(19) United States
(12) Patent Application Publication
(10) Pub. No.: US 2022/0332047 A1
(43) Pub. Date: Oct. 20, 2022

(54) Z-STAGE ASSEMBLY FOR ADDITIVE MANUFACTURING MACHINE

(71) Applicant: Essentium, Inc., Pflugerville, TX (US)

(72) Inventors: Erik John Gjovik, Aliso Viejo, CA (US); William Jack MacNeish, III, Santa Ana, CA (US)

(21) Appl. No.: 17/835,578

(22) Filed: Jun. 8, 2022

Related U.S. Application Data
(63) Continuation of application No. PCT/US20/24682, filed on Mar. 25, 2020.
(60) Provisional application No. 62/945,395, filed on Dec. 9, 2019.

(51) Int. Cl. B29C 64/232; B33Y 30/00

(52) U.S. Cl. CPC B29C 64/232; B33Y 30/00

(57) ABSTRACT

A Z-Stage assembly for an additive manufacturing machine includes a Z-frame adapted to support a build table within an additive manufacturing machine, a first support element adapted to support the Z-frame, the first support element adapted to control the position of the Z-frame along an x-axis, a y-axis and a z-axis, a second support element adapted to support the Z-frame, the second support element adapted to control the position of the Z-frame along only the z-axis, and a third support element adapted to support the Z-frame, the third support element adapted to control the position of the Z-frame along the y-axis and the z-axis, wherein, each of the first, second and third support elements are adapted to selectively and independently move the Z-frame along the z-axis and to independently allow pivotal motion of the Z-frame relative to the first, second and third support elements.

### INTRODUCTION

The present disclosure relates to a machine for producing additive printed parts, and more particularly to a high-speed extrusion machine having features that support a build table within the machine.

Using additive manufacturing to create precisely dimensioned components requires that the additive manufacturing machine provide a stable build table that can be precisely positioned and must be insulated from vibrations and movement of the frame of the machine during manufacturing. Vibration insulation can be accomplished using flexible isolation elements, such as rubber mounts. Flexible isolation elements provide isolation from exterior vibrations, however, this type of flexible isolation element is prone to deterioration over time. As these elements deteriorate, their efficiency at isolating the build table from exterior vibrations diminishes, and eventually leads to replacement. In addition, this type of isolation element may be sensitive to thermal conditions, wherein their ability to isolate vibrations from the build table are affected by the ambient temperature within and around the machine.

In addition, precise operation of an additive manufacturing machine depends on keeping the build table perfectly level. Overtime, the level of the machine may be affected by fatigue due to repetitive vibration and usage.

Therefore, while current machines achieve their intended purpose, there is a need for an improved additive manufacturing machine having a z-platform that is isolated from vibration without using flexible isolation elements and allows fine-tuning to keep the build table level independently of the leveling of the additive manufacturing machine itself.

### SUMMARY

According to several aspects of the present disclosure, a Z-Stage assembly for an additive manufacturing machine includes a z-frame adapted to support a build table within an additive manufacturing machine, a first support element adapted to support the z-frame and to control the position of the z-frame along an x-axis, a y-axis and a z-axis, a second support element adapted to support the z-frame and to control the position of the z-frame along only the z-axis, and a third support element adapted to support the z-frame and to control the position of the z-frame along the y-axis and the z-axis, wherein, each of the first, second and third support elements are adapted to selectively and independently move the z-frame along the z-axis and to independently allow pivotal motion of the z-frame relative to the first, second and third support elements.

According to another aspect, each of the first, second and third support elements are moveably supported within the additive manufacturing machine to allow precise control of movement and positioning of the first, second and third support elements along the z-axis.

According to another aspect, the first, second and third support elements are moveably supported within the additive manufacturing machine by one of a geared mechanism and an electric motor.

According to another aspect, the first support element is supported on a first ball screw, the second support element is supported on a second ball screw and the third support element is supported on a third ball screw 30.

According to another aspect, the first ball screw is threadingly engaged with the first support element, the second ball screw is threadingly engaged with the second support element and the third ball screw is threadingly engaged with the third support element, further wherein rotation of the first ball screw in a first direction causes the first support element to move upward along the z-axis, and rotation of the first ball screw in a second direction, opposite the first direction, causes the first support element to move downward along the z-axis, and rotation of the second ball screw in the first direction causes the second support element to move upward along the z-axis, and rotation of the second ball screw in the second direction, causes the second support element to move downward along the z-axis, and rotation of the third ball screw in the first direction causes the third support element to move upward along the z-axis, and rotation of the third ball screw in the second direction, causes the third support element to move downward along the z-axis.

According to another aspect, each of the first, second and third ball screws are connected to a motor that is adapted to selectively rotate an associated one of the first, second and third ball screw in the first and second directions.

According to another aspect, each motor is independently operable, and each of the first, second and third ball screws are independently rotatable, and the first, second and third support elements are independently moveable upward and downward along the z-axis.

According to another aspect, the first support element includes a first carriage block and a first support block supported on the first carriage block, the first ball screw extending through and threadingly engaged with the first carriage block, the second support element includes a second carriage block and a second support block supported on the second carriage block, the second ball screw extending through and threadingly engaged with the second carriage block, and the third support element includes a third carriage block and a third support block supported on the third carriage block, the third ball screw extending through and threadingly engaged with the third carriage block, each of the first, second and third carriage blocks including a channel formed within a side that extends vertically between a top surface and a bottom surface.

According to another aspect, the Z-Stage assembly further includes three linear bearing carriages, one linear bearing carriage extending vertically parallel to, and spaced from each of the first, second and third ball screws, one linear bearing carriage in engagement with the channel in each of the first, second and third carriage blocks to provide support and to prevent rotation of the first, second and third carriage blocks, wherein when one of the first, second and third ball screws is rotated in the first or second direction, the corresponding carriage block does not rotate, and the threaded engagement between the carriage block and the ball screw causes the carriage block to move upward or downward along the z-axis.

According to another aspect, each channel includes a bearing carriage seal adapted to engage the corresponding linear bearing carriage.

According to another aspect, the first, second and third support blocks are pivotably supported on the first, second and third carriage blocks.

According to another aspect, each of the first, second and third carriage blocks includes a pair of springs adapted to provide a resilient biasing force to hold the first, second and third support blocks level with respect to the first, second and third carriage blocks, respectively.

According to another aspect, the first carriage block includes a circular recess formed within a top surface therein that is concentric with and extends around the first ball screw, and the first support block includes a generally U-shaped notch formed therein to provide clearance between the first support block and the first ball screw to allow the first support block to be placed onto the top surface of the first carriage block and allow rotation of the first ball screw without interference from the first support block, and to allow movement of the first support block relative to the first carriage block without interference from the first ball screw.

According to another aspect, the first support block includes a circular lip extending downward from a bottom surface, the circular lip of the first support block being received within the circular recess formed within the top surface of the first carriage block, the engagement of the lip of the first support block and the recess of the first carriage block preventing side to side motion of the first support block relative to the first carriage block along both the x-axis and the y-axis.

According to another aspect, the lip extending from the bottom surface of the first support block and the recess formed within the top surface of the first carriage block is adapted to allow pivotal motion of the first support block relative to the first carriage block.

According to another aspect, the second carriage block includes a roller pin positioned adjacent to and extending above the top surface of the second carriage block, the Z-frame including a support pin extending horizontally from the Z-frame and supported on the roller pin.

According to another aspect, the second support block is slidably supported on the support pin and is slidably supported relative to the second carriage block such that the second support block is free to move relative to the second carriage block along both the x-axis and the y-axis.

According to another aspect, the third carriage block includes a slot formed within the top surface therein that is concentric with the third ball screw, and the third support block includes a generally U-shaped notch formed therein to provide clearance between the third support block and the third ball screw to allow the third support block to be placed onto the top surface of the third carriage block and allow rotation of the third ball screw without interference from the third support block, and to allow movement of the third support block relative to the third carriage block without interference from the third ball screw.

According to another aspect, the third support block includes a circular lip extending downward from a bottom surface, the circular lip of the third support block being received within the slot formed within the top surface of the third carriage block, the engagement of the lip of the third support block and the slot of the third carriage block preventing side to side motion of the third support block relative to the third carriage block along the y-axis and allows side to side motion of the third support block relative to the third carriage block along the x-axis.

According to another aspect, the lip extending from the bottom surface of the third support block and the slot formed within the top surface of the third carriage block is adapted to allow pivotal motion of the third support block relative to the third carriage block.

According to several aspects of the present disclosure, a Z-Stage assembly for an additive manufacturing machine includes a Z-frame adapted to support a build table within an additive manufacturing machine, a first support element supported on a first ball screw and adapted to support the Z-frame and to control the position of the Z-frame along an x-axis, a y-axis and a z-axis, the first support element including a first carriage block and a first support block pivotably supported on the first carriage block, the first ball screw extending through and threadingly engaged with the first carriage block, a second support element supported on a second ball screw and adapted to support the Z-frame and to control the position of the Z-frame along only the z-axis, the second support element including a second carriage block and a second support block pivotably supported on the second carriage block, the second ball screw extending through and threadingly engaged with the second carriage block, and a third support element supported on a third ball screw and adapted to support the Z-frame and to control the position of the Z-frame along the y-axis and the z-axis, the third support element including a third carriage block and a third support block pivotably supported on the third carriage block, the third ball screw extending through and threadingly engaged with the third carriage block, wherein, each of the first, second and third support elements are independently moveable within the additive manufacturing machine to allow precise control of movement and positioning of the first, second and third support elements along the z-axis to move the Z-frame along the z-axis, and each of the first, second and third support elements are adapted to independently allow pivotal motion of the Z-frame relative to the first, second and third support elements.

According to another aspect, the first carriage block includes a circular recess formed within a top surface therein that is concentric with and extends around the first ball screw, the first support block includes a circular lip extending downward from a bottom surface, the circular lip of the first support block being received within the circular recess formed within the top surface of the first carriage block and preventing side to side motion of the first support block relative to the first carriage block along both the x-axis and the y-axis, the first support block further including a generally U-shaped notch formed therein to provide clearance between the first support block and the first ball screw to allow the first support block to be placed onto the top surface of the first carriage block and allow rotation of the first ball screw without interference from the first support block, and to allow pivotal movement of the first support block relative to the first carriage block without interference from the first ball screw.

According to another aspect, the second carriage block includes a roller pin positioned adjacent to and extending above the top surface of the second carriage block, the Z-frame includes a support pin extending horizontally from the Z-frame and supported on the roller pin, and the second support block is slidably supported on the support pin and slidably supported relative to the second carriage block such that the second support block is free to move relative to the second carriage block along both the x-axis and the y-axis.

According to another aspect, the third carriage block includes a slot formed within the top surface therein that is concentric with the third ball screw, the third support block including a circular lip extending downward from a bottom surface, the circular lip of the third support block being received within the slot formed within the top surface of the third carriage block, preventing side to side motion of the third support block relative to the third carriage block along the y-axis and allowing side to side motion of the third support block relative to the third carriage block along the x-axis, the third support block further including a generally U-shaped notch formed therein to provide clearance between the third support block and the third ball screw to allow the third support block to be placed onto the top surface of the third carriage block and allow rotation of the third ball screw without interference from the third support block, and to allow pivotal movement of the third support block relative to the third carriage block without interference from the third ball screw.

According to another aspect, each of the first, second and third carriage blocks includes a channel formed within a side that extends vertically between a top surface and a bottom surface, the Z-Stage assembly further including three linear bearing carriages, one linear bearing carriage extending vertically parallel to, and spaced from each of the first, second and third ball screws, one linear bearing carriage in engagement with the channel in each of the first, second and third carriage blocks to provide support and to prevent rotation of the first, second and third carriage blocks, relative to the first, second and third ball screws, each channel including a bearing carriage seal adapted to engage the corresponding linear bearing carriage.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a frame for an additive manufacturing machine according to an exemplary embodiment;

FIG. 2 is a perspective view of a Z-Stage assembly for the additive manufacturing machine shown in FIG. 1;

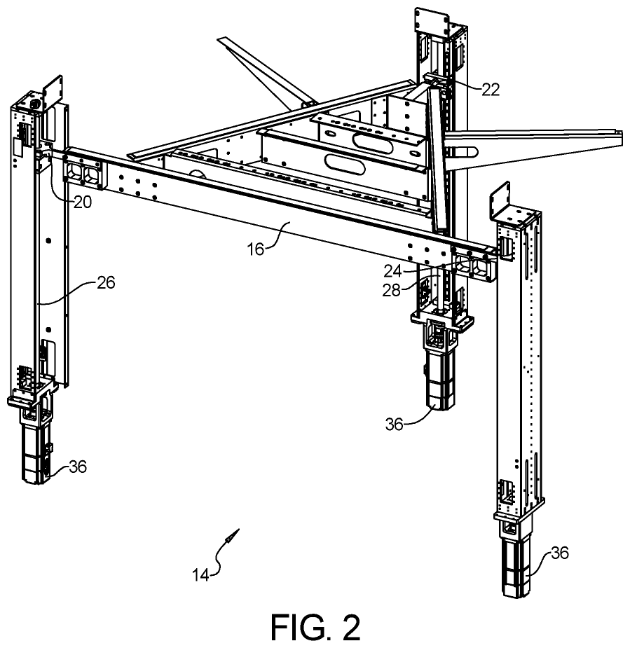

FIG. 3 is a perspective view of a first support element for the Z-Stage assembly shown in FIG. 3;

FIG. 4. is a perspective view of a second support element for the Z-Stage assembly shown in FIG. 3;

FIG. 5 is a perspective view of a third support element for the Z-Stage assembly shown in FIG. 3; and

FIG. 6 is a perspective view of a ball support for the Z-Stage assembly shown in FIG. 3.

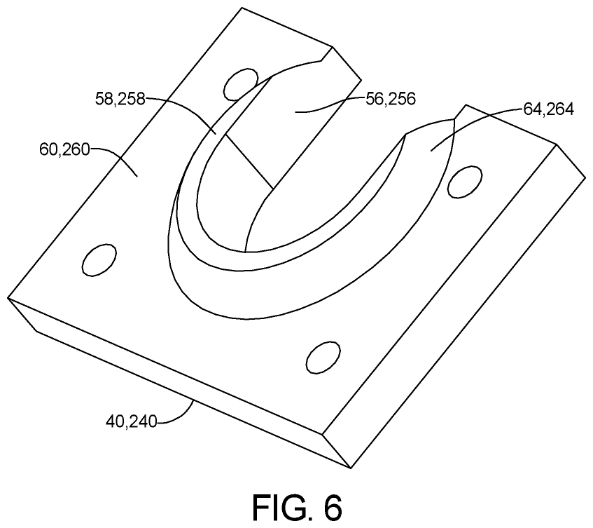

### DETAILED DESCRIPTION

The following description is merely exemplary in nature and is not intended to limit the present disclosure, application, or uses.

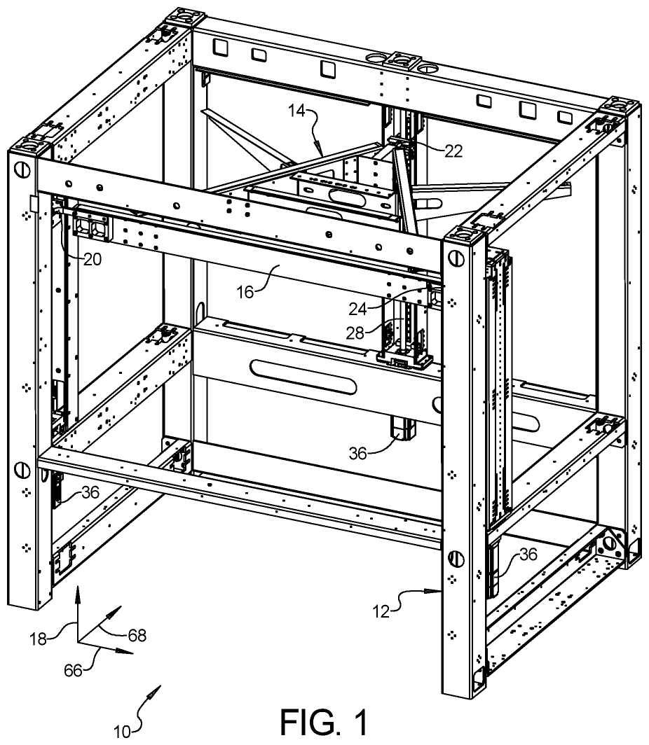

Referring to FIG. 1, a machine for producing an additive printed part is generally shown at 10. The machine 10 includes a machine frame 12 and a Z-Stage assembly 14. The machine frame 12 supports side walls (not shown) that define an interior space of the machine 10. The Z-Stage assembly 14 includes a Z-frame 16 that is moveably supported thereon. The Z-frame 16 is adapted to support a build table (not shown) mounted thereon. The Z-frame 16 is vertically movable relative to the machine frame 12 along a z-axis 18, whereby a build table can be moved vertically within the machine 10 during an additive manufacturing process.

The Z-frame 16 is supported on the Z-Stage assembly 14 by a first support element 20, a second support element 22 and a third support element 24. Each of the first support element 20, second support element 22 and third support element 24 are vertically moveable along the z-axis 18. The Z-Stage assembly 14 includes a mechanism associated with each of the first, second and third support elements 20, 22, 24 that is adapted to independently move the first, second and third support elements 20, 22, 24. In an exemplary embodiment, as shown in the figures, the first support element 20 is supported on a first ball screw 26, the second support element 22 is supported on a second ball screw 28 and the third support element 24 is supported on a third ball screw 30.

The first ball screw 26 is threadingly engaged with the first support element 20, such that rotation of the first ball screw 26 in a first direction 32 causes the first support element 20 to move upward along the z-axis 18, and rotation of the first ball screw 26 in a second direction 34, opposite the first direction 32, causes the first support element 20 to move downward along the z-axis 18. Correspondingly, The second and third ball screws 28, 30 are threadingly engaged with the second and third support elements 22, 24, respectively, such that rotation of the second and third ball screws 28, 30 in the first direction 32 causes the second and third support elements 22, 24 to move upward along the z-axis 18, and rotation of the second and third ball screws 28, 30 in the second direction 34, opposite the first direction 32, causes the second and third support elements 22, 24 to move downward along the z-axis 18.

Each of the first, second and third ball screws 26, 28, 30 are connected to a motor 36. Each motor 36 is adapted to selectively rotate an associated ball screw 26, 28, 30 in the first and second directions 32, 34. Each of the motors 36 is independently operable, such that the first, second and third ball screws 26, 28, 30 are independently rotatable and the first, second and third support elements 20, 22, 24 are independently moveable upward and downward along the z-axis 18.

The first, second and third ball screws 26, 28, 30 provide precise control of movement and positioning of the first, second and third support elements 20, 22, 24 along the z-axis 18. It is to be understood that the first, second and third support elements 20, 22, 24 may be supported and moved by any suitable means, such as by way of non-limiting examples, a geared mechanism, such as a rack and pinion, or an electric motor, such as a linear servo motor.

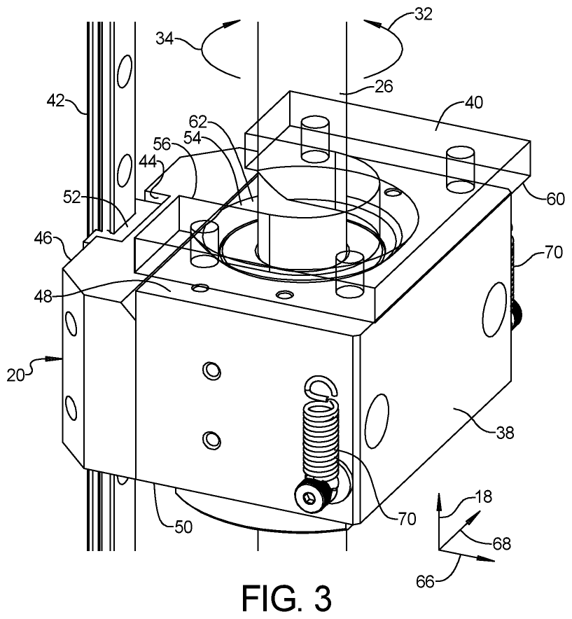

Referring to FIG. 3, the first support element 20 includes a first carriage block 38, and a first support block 40 supported on the first carriage block 38. The first ball screw 26 extends through and is threadingly engaged with the first carriage block 38. The Z-Stage assembly 14 further includes a first linear bearing carriage 42 extending vertically parallel to, and spaced from the first ball screw 26. The first carriage block 38 includes a first channel 44 formed within a side 46 that extends vertically between a top surface 48 and bottom surface 50 of the first carriage block 38. The first linear bearing carriage 42 is in engagement with the first channel 44 to provide support for the first carriage block 38. The first linear bearing carriage 42 prevents rotation of the first carriage block 38, wherein, when the first ball screw 26 is rotated in the first or second direction 32, 34, the first carriage block 38 does not rotate, and the threaded engagement between the first carriage block 38 and the first ball screw 26 causes the first carriage block 38 to move upward or downward along the z-axis 18 when the first ball screw 26 is rotated. In an exemplary embodiment, as shown in FIG. 3, the first channel includes a bearing carriage seal 52 adapted to engage the first linear bearing carriage 42.

The first support block 40 rests on the top surface 48 of the first carriage block 38. The first support block 40 is adapted to be attached to a build table to support the build table on the first carriage block 38. The first carriage block 38 includes a circular recess 54 formed therein that is concentric with and extends around the first ball screw 26. The first support block 40 includes a generally U-shaped notch 56 formed therein. The U-shaped notch 56 provides clearance between the first support block 40 and the first ball screw 26 to allow the first support block 40 to be placed onto the top surface 48 of the first carriage block 38, to allow rotation of the first ball screw 26 without interference from the first support block 40, and to allow movement of the first support block 40 relative to the first carriage block 38 without interference from the first ball screw 26.

The first support block 40 includes a circular lip 58 extending downward from a bottom surface 60 of the first support block 40 that is received within the circular recess 54 formed within the top surface 48 of the first carriage block 38. In an exemplary embodiment, the circular recess 54 formed within the top surface 48 of the first carriage block 38 includes concave curved sides 62 that provide a bowl-shaped circular recess 54 and the circular lip 58 extending from the bottom surface 60 of the first support block 40 includes convex curved sides 64 having substantially the same profile as the concave curved sides 62 of the circular recess 54 formed within the top surface 48 of the first carriage block 38. Alternatively, the circular recess 54 formed within the top surface 48 of the first carriage block 38 may provide a conical recess and the circular lip 58 extending from the bottom surface 50 of the first support block 40 includes straight sides having substantially the same profile as the conical recess formed within the top surface 48 of the first carriage block 38.

The engagement of the lip 58 of the first support block 40 and the recess 54 of the first carriage block 38 prevents side to side motion of the first support block 40 relative to the first carriage block 38 along both an x-axis 66 and a y-axis 68, while allowing rotational motion of the first support block 40 relative to the first carriage block 38 about both the x-axis 66 and the y-axis 68. The first support block 40 acts much like a ball socket within the recess 54 of the first carriage block 38, allowing slight angular rotation of the Z-frame 16 relative to the first carriage block 38 to accommodate deviation between the first support element 20 and the second and third support elements 22, 24 along the z-axis 18, when the Z-frame 16 is being moved vertically along the z-axis 18. Movement of the first carriage block 38 upward and downward along the z-axis 18 controls the position of the first support block 40 along the z-axis 18. The build table of the machine 10 is supported on the first carriage block 38 by the first support block 40. The first carriage block 38 and the first support block 40 provide a single datum that controls the position of the build table along the x-axis 66, the y-axis 68, and the z-axis 18.

The engagement of the lip 58 extending from the bottom surface 60 of the first support block 40 and the recess 54 formed within the top surface 48 of the first carriage block 38 acts similarly to a ball socket, allowing pivotal motion of the first support block 40 relative to the first carriage block 38. This allows slight deviation between the first support element 20 and the second and third support elements 22, 24 when the Z-frame 16 is being moved vertically along the z-axis 18. The first carriage block 38 includes a pair of springs 70. One spring 70 is positioned on either side of the first carriage block 38. Each spring 70 is attached at one end to the first carriage block 38 and at an opposite end to the first support block 40. The pair of springs 70 provides a resilient biasing force to hold the first support block 40 level with respect to the first carriage block 38, while allowing pivotal motion of the first support block 40 relative to the first carriage block 38 when the position of the first support element 20 along the z-axis 18 varies slightly from the position of the second and third support elements 22, 24 along the z-axis 18.

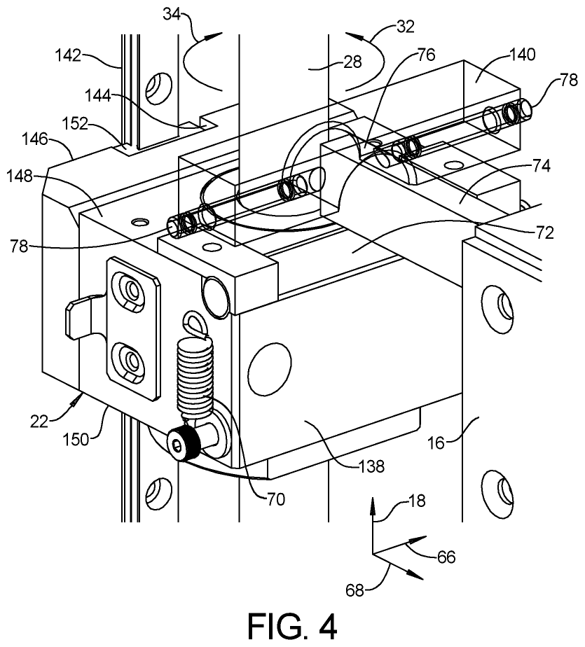

Referring to FIG. 4, the second support element 22 includes a second carriage block 138, and a second support block 140 supported on the second carriage block 138. The second ball screw 28 extends through and is threadingly engaged with the second carriage block 138. The Z-Stage assembly 14 further includes a second linear bearing carriage 142 extending vertically parallel to, and spaced from the second ball screw 28. The second carriage block 138 includes a second channel 144 formed within a side 146 that extends vertically between a top surface 148 and bottom surface 150 of the second carriage block 138. The second linear bearing carriage 142 is in engagement with the second channel 144 to provide support for the second carriage block 138. The second linear bearing carriage 142 prevents rotation of the second carriage block 138, wherein, when the second ball screw 28 is rotated in the first or second direction 32, 34, the second carriage block 138 does not rotate, and the threaded engagement between the second carriage block 138 and the second ball screw 28 causes the second carriage block 138 to move upward or downward along the z-axis 18 when the second ball screw 28 is rotated.

In an exemplary embodiment, as shown in FIG. 4, the second channel 144 includes a bearing carriage seal 152 adapted to engage the second linear bearing carriage 142.

The second carriage block 138 includes a roller pin 72 positioned adjacent to and extending above the top surface 148 of the second carriage block 138. The Z-frame 16 includes a support pin 74 extending horizontally from the Z-frame 16. The support pin 74 is oriented perpendicular to the roller pin 72. A distal end 76 of the support pin 74 is supported on the roller pin 72. The roller pin 72 supports the support pin 74 and allows the support pin 74 to move relative to the second carriage block 138 along the y-axis 68.

The second support block 140 is slidably supported on the distal end 76 of the support pin 74. Slide pins 78 extending into opposing sides of the second support block 140 allow the second support block 140 to move relative to the second carriage block 138 along the x-axis 66. Rolling engagement of the support pin 74 with the roller pin 72 and sliding engagement of the support pin 74 with the second support block 140 allows the support pin 74, and the Z-frame 16, to move relative to the second carriage block 138 along the y-axis 68, and sliding engagement of the second support block 140 on the slide pins 78 allow the support pin 74, and the Z-frame 16, to move relative to the second carriage block 138 along the x-axis 66. Thus, the second support element 22 controls the position of a build table mounted onto the Z-frame 16 along only the z-axis 18, while allowing free movement along the x-axis 66 and the y-axis 68.

The second support block 140 is supported on the support pin 74 above the top surface 148 of the second carriage block 140. The top surface of the support pin 74 is rounded. The second support block 140 includes a semi-circular notch that corresponds to the rounded top surface of the support pin 74, such that the support pin 74 is free to rotate relative to the second support block 140 and the second carriage block 138, about the y-axis 68. This allows slight angular rotation of the Z-frame 16 relative to the second carriage block 138 to accommodate deviation between the second support element 22 and the first and third support elements 20, 24 along the z-axis 18, when the Z-frame 16 is being moved vertically along the z-axis 18. The second carriage block 140 includes a pair of springs 70. One spring 70 is positioned on either side of the second carriage block 140. Each spring 70 is attached at one end to the second carriage block 138 and at an opposite end to the second support block 140. The pair of springs 70 provides a resilient biasing force to hold the second support block 140 level with respect to the second carriage block 138, while allowing pivotal motion of the second support block 140 relative to the second carriage block 138 when the position of the second support element 22 along the z-axis 18 varies slightly from the position of the first and third support elements 20, 24 along the z-axis 18.

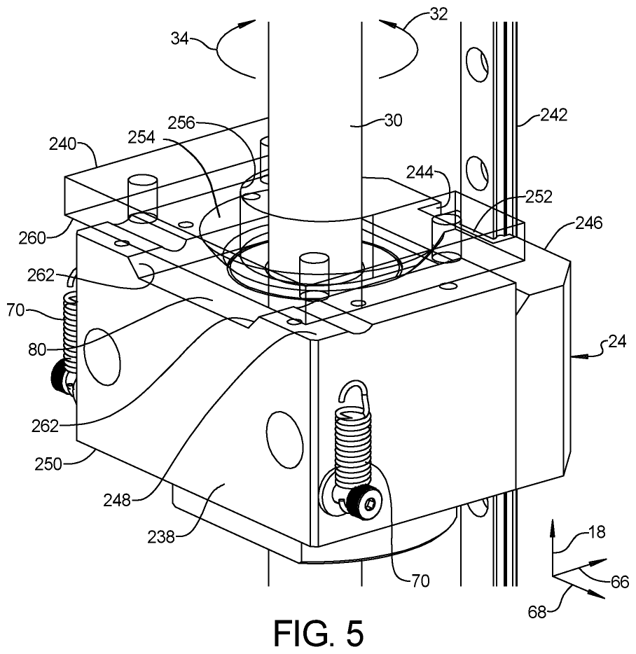

Referring to FIG. 5, the third support element 24 includes a third carriage block 238, and a third support block 240 supported on the third carriage block 238. The first and third support blocks 38, 238 are substantially identical to one another. The third ball screw 30 extends through and is threadingly engaged with the third carriage block 238. The Z-Stage assembly 14 further includes a third linear bearing carriage 242 extending vertically parallel to, and spaced from the third ball screw 30. The third carriage block 238 includes a third channel 244 formed within a side 246 that extends vertically between a top surface 248 and bottom surface 250 of the third carriage block 238. The third linear bearing carriage 242 is in engagement with the third channel 244 to provide support for the third carriage block 238. The third linear bearing carriage 242 prevents rotation of the third carriage block 238, wherein, when the third ball screw 30 is rotated in the first or second direction 32, 34, the third carriage block 238 does not rotate, and the threaded engagement between the third carriage block 238 and the third ball screw 30 causes the third carriage block 238 to move upward or downward along the z-axis 18 when the third ball screw 30 is rotated.

In an exemplary embodiment, as shown in FIG. 5, the third channel 244 includes a bearing carriage seal 252 adapted to engage the third linear bearing carriage 242.

The third support block 240 rests on the top surface 248 of the third carriage block 238. The third support block 240 is adapted to be attached to a build table to support the build table on the third carriage block 238. The top surface 248 of the third carriage block 238 includes a slot 80 formed therein. The third ball screw 30 extends through the third carriage block 238 centered within the slot 80. The third support block 240 includes a generally U-shaped notch 256 formed therein. The U-shaped notch 256 provides clearance between the third support block 240 and the third ball screw 30 to allow the third support block 240 to be placed onto the top surface 248 of the third carriage block 238, to allow rotation of the third ball screw 30 without interference from the third support block 240, and to allow movement of the third support block 240 relative to the third carriage block 238 without interference from the third ball screw 30.

The third support block 240 includes a circular lip 258 extending downward from a bottom surface 260 of the third support block 240 that is received within the slot 80 formed within the top surface 248 of the third carriage block 238. In an exemplary embodiment, the slot 80 formed within the top surface 248 of the third carriage block 238 includes concave curved sides 262 that provide a u-shaped recess 254 and the circular lip 258 extending from the bottom surface 260 of the third support block 240 includes convex curved sides 264 having substantially the same profile as the concave curved sides 264 of the slot 80 formed within the top surface 248 of the third carriage block 238. Alternatively, the slot 80 formed within the top surface 248 of the third carriage block 238 may have straight sides and the circular lip 258 extending from the bottom surface 260 of the third support block 240 includes straight sides having substantially the same profile as the slot 80 formed within the top surface 248 of the third carriage block 238, as shown in FIG. 5.

The engagement of the lip 258 of the third support block 240 and the slot 80 of the third carriage block 238 prevents side to side motion of the third support block 240 relative to the third carriage block 238 along the y-axis 68, while allowing side to side motion of the third support block 240 relative to the third carriage block 238 along the x-axis 66 and rotational motion of the third support block 240 relative to the third carriage block 238 about both the x-axis 66 and the y-axis 68. The third support block 240 acts much like a ball socket within the recess 254 of the third carriage block 238, allowing slight angular rotation of the Z-frame 16 relative to the third carriage block 238 to accommodate deviation between the third support element 24 and the first and second support elements 20, 22 along the z-axis 18, when the Z-frame 16 is being moved vertically along the z-axis 18. Movement of the third carriage block 238 upward and downward along the z-axis 18 controls the position of the third support block 240 along the z-axis 18. A build table of the machine 10 is supported on the third carriage block 238 by the third support block 240. The slot 80 formed within the top surface 248 of the third carriage block 238 allows sliding movement of the third support block 240 relative to the third carriage block 238 along the x-axis 66. Thus, the third support element 24 controls the position of a build table mounted onto the Z-frame 16 along the y-axis 68 and the z-axis 18, while allowing free movement along the x-axis 66.

The engagement of the lip 258 extending from the bottom surface 260 of the third support block 240 and the slot 80 formed within the top surface 248 of the third carriage block 238 acts similarly to a ball socket, allowing pivotal motion of the third support block 240 relative to the third carriage block 238. This allows slight deviation between the third support element 24 and the first and second support elements 20, 22 when the Z-frame 16 is being moved vertically along the z-axis 18. The third carriage block 238 includes a pair of springs 70. One spring 70 is positioned on either side of the third carriage block 238. Each spring 70 is attached at one end to the third carriage block 238 and at an opposite end to the third support block 240. The pair of springs 70 provides a resilient biasing force to hold the third support block 240 level with respect to the third carriage block 238, while allowing pivotal motion of the third support block 240 relative to the third carriage block 238 when the position of the third support element 24 along the z-axis 18 varies slightly from the position of the first and second support elements 20, 22 along the z-axis 18.

The engagement of the first support block 40 with the first carriage block 38, the engagement of the support pin 74 with the second carriage block 138 and the engagement of the third support block 240 with the third carriage block 238 allows relative motion of the Z-frame 16 and a build table mounted thereon from the machine frame 12 of the additive manufacturing machine 10 without the use of flexible isolation elements. Further, the Z-frame 16 is independently allowed to pivotally move relative to each of the first, second and third support elements 20, 22, 24, allowing selective fine tuning of the level of the Z-frame 16 and an associated build table relative to and independently of the level of the machine frame 12 of the additive manufacturing machine 10.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A Z-Stage assembly for an additive manufacturing machine, comprising:
a Z-frame adapted to support a build table within an additive manufacturing machine;
a first support element adapted to support the Z-frame, the first support element adapted to control the position of the Z-frame along an x-axis, a y-axis and a z-axis;
a second support element adapted to support the Z-frame, the second support element adapted to control the position of the Z-frame along only the z-axis; and
a third support element adapted to support the Z-frame, the third support element adapted to control the position of the Z-frame along the y-axis and the z-axis;
wherein, each of the first, second and third support elements are adapted to selectively and independently move the Z-frame along the z-axis and to independently allow pivotal motion of the Z-frame relative to the first, second and third support elements.

2. The Z-Stage assembly of claim 1, wherein each of the first,
second and third support elements are moveably supported within the additive manufacturing machine to allow precise control of movement and positioning of the first, second and third support elements along the z-axis.

3. The Z-Stage assembly of claim 2, wherein the first, second and third support elements are moveably supported within the additive manufacturing machine by one of a geared mechanism and an electric motor.

4. The Z-Stage assembly of claim 2, wherein the first support element is supported on a first ball screw, the second support element is supported on a second ball screw and the third support element is supported on a third ball screw.

5. The Z-Stage assembly of claim 4, wherein the first ball screw is threadingly engaged with the first support element, the second ball screw is threadingly engaged with the second support element and the third ball screw is threadingly engaged with the third support element, further wherein rotation of the first ball screw in a first direction causes the first support element to move upward along the z-axis, and rotation of the first ball screw in a second direction, opposite the first direction, causes the first support element to move downward along the z-axis, and rotation of the second ball screw in the first direction causes the second support element to move upward along the z-axis, and rotation of the second ball screw in the second direction, causes the second support element to move downward along the z-axis, and rotation of the third ball screw in the first direction causes the third support element to move upward along the z-axis, and rotation of the third ball screw in the second direction, causes the third support element to move downward along the z-axis.

6. The Z-Stage assembly of claim 5, wherein each of the first, second and third ball screws are connected to a motor that is adapted to selectively rotate an associated one of the first, second and third ball screw in the first and second directions.

7. The Z-Stage assembly of claim 6, wherein each motor is independently operable, and each of the first, second and third ball screws are independently rotatable, and the first, second and third support elements are independently moveable upward and downward along the z-axis.

8. The Z-Stage assembly of claim 7, wherein the first support element includes a first carriage block and a first support block supported on the first carriage block, the first ball screw extending through and threadingly engaged with the first carriage block, the second support element includes a second carriage block and a second support block supported on the second carriage block, the second ball screw extending through and threadingly engaged with the second carriage block, and the third support element includes a third carriage block and a third support block supported on the third carriage block, the third ball screw extending through and threadingly engaged with the third carriage block, each of the first, second and third carriage blocks including a channel formed within a side that extends vertically between a top surface and a bottom surface.

9. The Z-Stage assembly of claim 8, further including three linear bearing carriages, one guide rail extending vertically parallel to, and spaced from each of the first, second and third ball screws, one linear bearing carriage in engagement with the channel in each of the first, second and third carriage blocks to provide support and to prevent rotation of the first, second and third carriage blocks, wherein when one of the first, second and third ball screws is rotated in the first or second direction, the corresponding carriage block does not rotate, and the threaded engagement between the carriage block and the ball screw causes the carriage block to move upward or downward along the z-axis.

10. The Z-Stage assembly of claim 9, wherein each channel includes a bearing carriage seal adapted to engage the corresponding linear bearing carriage.

11. The Z-Stage assembly of claim 9, wherein the first, second and third support blocks are pivotably supported on the first, second and third carriage blocks.

12. The Z-Stage assembly of claim 11, wherein each of the first, second and third carriage blocks includes a pair of springs adapted to provide a resilient biasing force to hold the first, second and third support blocks level with respect to the first, second and third carriage blocks, respectively.

13. The Z-Stage assembly of claim 11, wherein the first carriage block includes a circular recess formed within a top surface therein that is concentric with and extends around the first ball screw, and the first support block includes a generally U-shaped notch formed therein to provide clearance between the first support block and the first ball screw to allow the first support block to be placed onto the top surface of the first carriage block and allow rotation of the first ball screw without interference from the first support block, and to allow movement of the first support block relative to the first carriage block without interference from the first ball screw.

14. The Z-Stage assembly of claim 13, wherein the first support block includes a circular lip extending downward from a bottom surface, the circular lip of the first support block being received within the circular recess formed within the top surface of the first carriage block, the engagement of the lip of the first support block and the recess of the first carriage block preventing side to side motion of the first support block relative to the first carriage block along both the x-axis and the y-axis.

15. The Z-Stage assembly of claim 14, wherein the lip extending from the bottom surface of the first support block and the recess formed within the top surface of the first carriage block is adapted to allow pivotal motion of the first support block relative to the first carriage block.

16. The Z-Stage assembly of claim 11, wherein the second carriage block includes a roller pin positioned adjacent to and extending above the top surface of the second carriage block, the Z-frame including a support pin extending horizontally from the Z-frame and supported on the roller pin.

17. The Z-Stage assembly of claim 16, wherein the second support block is slidably supported on the support pin and is slidably supported relative to the second carriage block such that the second support block is free to move relative to the second carriage block along both the x-axis and the y-axis.

18. The Z-Stage assembly of claim 11, wherein the third carriage block includes a slot formed within the top surface therein that is concentric with the third ball screw, and the third support block includes a generally U-shaped notch formed therein to provide clearance between the third support block and the third ball screw to allow the third support block to be placed onto the top surface of the third carriage block and allow rotation of the third ball screw without interference from the third support block, and to allow movement of the third support block relative to the third carriage block without interference from the third ball screw.

19. The Z-Stage assembly of claim 18, wherein the third support block includes a circular lip extending downward from a bottom surface, the circular lip of the third support block being received within the slot formed within the top surface of the third carriage block, the engagement of the lip of the third support block and the slot of the third carriage block preventing side to side motion of the third support block relative to the third carriage block along the y-axis and allows side to side motion of the third support block relative to the third carriage block along the x-axis.

20. The Z-Stage assembly of claim 19, wherein the lip extending from the bottom surface of the third support block and the slot formed within the top surface of the third carriage block is adapted to allow pivotal motion of the third support block relative to the third carriage block.

21. A Z-Stage assembly for an additive manufacturing machine, comprising:
a Z-frame adapted to support a build table within an additive manufacturing machine;
a first support element supported on a first ball screw and adapted to support the Z-frame and to control the position of the Z-frame along an x-axis, a y-axis and a z-axis, the first support element including a first carriage block and a first support block pivotably supported on the first carriage block, the first ball screw extending through and threadingly engaged with the first carriage block;
a second support element supported on a second ball screw and adapted to support the Z-frame and to control the position of the Z-frame along only the z-axis, the second support element including a second carriage block and a second support block pivotably supported on the second carriage block, the second ball screw extending through and threadingly engaged with the second carriage block; and
a third support element supported on a third ball screw and adapted to support the Z-frame and to control the position of the Z-frame along the y-axis and the z-axis, the third support element including a third carriage block and a third support block pivotably supported on the third carriage block, the third ball screw extending through and threadingly engaged with the third carriage block; and
wherein, each of the first, second and third support elements are independently moveable within the additive manufacturing machine to allow precise control of movement and positioning of the first, second and third support elements along the z-axis to move the Z-frame along the z-axis, and each of the first, second and third support elements are adapted to independently allow pivotal motion of the Z-frame relative to the first, second and third support elements.

22. The Z-Stage assembly of claim 21, wherein the first carriage block includes a circular recess formed within a top surface therein that is concentric with and extends around the first ball screw, the first support block includes a circular lip extending downward from a bottom surface, the circular lip of the first support block being received within the circular recess formed within the top surface of the first carriage block and preventing side to side motion of the first support block relative to the first carriage block along both the x-axis and the y-axis, the first support block further including a generally U-shaped notch formed therein to provide clearance between the first support block and the first ball screw to allow the first support block to be placed onto the top surface of the first carriage block and allow rotation of the first ball screw without interference from the first support block, and to allow pivotal movement of the first support block relative to the first carriage block without interference from the first ball screw.

23. The Z-Stage assembly of claim 22, wherein the second carriage block includes a roller pin positioned adjacent to and extending above the top surface of the second carriage block, the Z-frame includes a support pin extending horizontally from the Z-frame and supported on the roller pin, and the second support block is slidably supported on the support pin and slidably supported relative to the second carriage block such that the second support block is free to move relative to the second carriage block along both the x-axis and the y-axis.

24. The Z-Stage assembly of claim 23, wherein the third carriage block includes a slot formed within the top surface therein that is concentric with the third ball screw, the third support block including a circular lip extending downward from a bottom surface, the circular lip of the third support block being received within the slot formed within the top surface of the third carriage block, preventing side to side motion of the third support block relative to the third carriage block along the y-axis and allowing side to side motion of the third support block relative to the third carriage block along the x-axis, the third support block further including a generally U-shaped notch formed therein to provide clearance between the third support block and the third ball screw to allow the third support block to be placed onto the top surface of the third carriage block and allow rotation of the third ball screw without interference from the third support block, and to allow pivotal movement of the third support block relative to the third carriage block without interference from the third ball screw.

25. The Z-Stage assembly of claim 24, wherein each of the first, second and third carriage blocks includes a channel formed within a side that extends vertically between a top surface and a bottom surface, the Z-Stage assembly further including three linear bearing carriages, one linear bearing carriage extending vertically parallel to, and spaced from each of the first, second and third ball screws, one linear bearing carriage in engagement with the channel in each of the first, second and third carriage blocks to provide support and to prevent rotation of the first, second and third carriage blocks, relative to the first, second and third ball screws, each channel including a bearing carriage seal adapted to engage the corresponding linear bearing carriage.
